(19) United States
(12) Patent Application Publication
(10) Pub. No.: US 2024/0377827 A1
(43) Pub. Date: Nov. 14, 2024

(54) CONTROLLING A VELOCITY OF AN AUTONOMOUS VEHICLE USING A VIRTUAL ENVELOPE

(71) Applicant: Mobile Industrial Robots A/S, Odense SØ (DK)

(72) Inventors: Glenn Aarhus Outzen, Odense SØ (DK); Olliver Ordell, Odense SØ (DK)

(21) Appl. No.: 18/196,668

(22) Filed: May 12, 2023

(51) Int. Cl. G05D 1/02

(52) U.S. Cl. CPC G05D 1/0223

(57) ABSTRACT

An example method includes obtaining information about a path that an autonomous vehicle is to travel during movement of the autonomous vehicle through an environment, and generating a virtual envelope that surrounds the autonomous vehicle and that has at least two dimensions that are greater than two corresponding dimensions of the autonomous vehicle. A length of the virtual envelope along the path is based on at least one of (i) a predefined duration that the autonomous vehicle can travel along the path or (ii) a duration that the autonomous vehicle can travel along the path without stopping. A velocity of the autonomous vehicle is based on the virtual envelope.

### TECHNICAL FIELD

This specification relates generally to example systems configured to generate a virtual envelope around at least part of an autonomous vehicle and to use the virtual envelope to control a velocity of the autonomous vehicle.

### BACKGROUND

Autonomous vehicles, such as mobile robots, are configured to travel within an environment, such as a warehouse. For example, an autonomous vehicle may plan a path or route through the environment using a map of the environment. During movement along the path, the autonomous vehicle may determine its location within the environment and use that location to control its future movements. When multiple autonomous vehicles operating in the same environment, there is a chance of collision between the autonomous vehicles.

### SUMMARY

An example method includes obtaining information about a path that an autonomous vehicle is to travel during movement of the autonomous vehicle through an environment, and generating a virtual envelope that surrounds the autonomous vehicle and that has at least two dimensions that are greater than two corresponding dimensions of the autonomous vehicle. A length of the virtual envelope along the path is based on at least one of (i) a predefined duration that the autonomous vehicle can travel along the path or (ii) a duration that the autonomous vehicle can travel along the path without stopping. A velocity of the autonomous vehicle is based on the virtual envelope. The example method may include one or more of the following features, either alone or in combination.

The autonomous vehicle may be a first autonomous vehicle and the path may be a first path. Generating the virtual envelope may include identifying an intersection of the first path and a second path that a second autonomous vehicle is to travel during movement of the second autonomous vehicle through the environment; determining that the first autonomous vehicle will have to stop prior to the intersection; and basing a length of the virtual envelope on how much time that the first autonomous vehicle can travel before stopping prior to the intersection. The method may include determining that travel of the second autonomous vehicle takes precedence over travel of the first autonomous vehicle and, therefore, that the first autonomous vehicle will have to stop prior to the intersection. The travel of the second autonomous vehicle may take precedence over the travel of the first autonomous vehicle because the second autonomous vehicle is predicted to reach the intersection before the first autonomous vehicle.

The autonomous vehicle may be a first autonomous vehicle and the path may be a first path. Generating the virtual envelope may include identifying a location where the first path is within a predefined distance of a second path that a second autonomous vehicle is to travel during movement of the second autonomous vehicle through the environment; determining that the first autonomous vehicle will have to stop prior to the location; and basing a length of the virtual envelope on how much time that the first autonomous vehicle can travel before stopping prior to the location. The method may include determining that travel of the second autonomous vehicle takes precedence over travel of the first autonomous vehicle and, therefore, that the first autonomous vehicle will have to stop prior to the location. The travel of the second autonomous vehicle may take precedence over the travel of the first autonomous vehicle because the second autonomous vehicle is predicted to reach the location before the first autonomous vehicle.

Generating the virtual envelope may include identifying a region where the autonomous vehicle is prohibited from entering; and basing a length of the virtual envelope on a proximity to the region.

Generating the virtual envelope may include identifying a region where the autonomous vehicle has primacy; and extending the virtual envelope into the region prior to entry of one or more other autonomous vehicles into the region.

Generating the virtual envelope may include updating a shape of the virtual envelope dynamically based on at least one of a velocity of the autonomous vehicle or obstacles in the path or within a predefined distance of the path.

The at least two dimensions of the virtual envelope may include a first dimension that is parallel to at least part of the path and a second dimension that is perpendicular to the first dimension. Generating the virtual envelope may include changing at least a size of the first dimension. Generating the virtual envelope may include combining polygons along the path to form a shape of the virtual envelope.

The virtual envelope that surrounds the autonomous vehicle may have at least three dimensions that are greater than three corresponding dimensions of the autonomous vehicle.

Examples of one or more non-transitory machine-readable storage media store instructions that are executable to perform operations that include: obtaining information about a path that an autonomous vehicle is to travel during movement of the autonomous vehicle through an environment; and generating a virtual envelope that surrounds the autonomous vehicle and that has at least two dimensions that are greater than two corresponding dimensions of the autonomous vehicle. A length of the virtual envelope along the path may be based on at least one of (i) a predefined duration that the autonomous vehicle can travel along the path or (ii) a duration that the autonomous vehicle can travel along the path without stopping. A velocity of the autonomous vehicle may be based on the virtual envelope. The one or more non-transitory machine-readable storage media may store instructions that are executable to perform any of the operations associated with the method and variants thereof described above or elsewhere herein.

An example system includes an autonomous vehicle and one or more processing devices configured to execute instructions to perform operations that include: obtaining information about a path that the autonomous vehicle is to travel during movement of the autonomous vehicle through an environment; and generating a virtual envelope that surrounds the autonomous vehicle and that has at least two dimensions that are greater than two corresponding dimensions of the autonomous vehicle. A length of the virtual envelope along the path is based on at least one of (i) a predefined duration that the autonomous vehicle can travel along the path or (ii) a duration that the autonomous vehicle can travel along the path without stopping. The autonomous vehicle is configured to use the virtual envelope to control a velocity of the autonomous vehicle. The system may include one or more of the following features, either alone or in combination.

The autonomous vehicle may be a first autonomous vehicle and the path may be a first path. The one or more processing devices may be configured to execute instructions to perform operations that include obtaining information about a second path that a second autonomous vehicle is to travel during movement of the second autonomous vehicle through the environment. Generating the virtual envelope may include: identifying an intersection of the first path and the second path; determining that the first autonomous vehicle will have to stop prior to the intersection; and basing a length of the virtual envelope on how much time that the first autonomous vehicle can travel before stopping prior to the intersection.

The one or more processing devices may be configured to execute instructions to perform operations that include determining that travel of the second autonomous vehicle takes precedence over travel of the first autonomous vehicle and, therefore, that the first autonomous vehicle will have to stop prior to the intersection. The travel of the second autonomous vehicle may take precedence over the travel of the first autonomous vehicle because the second autonomous vehicle is predicted to reach the intersection before the first autonomous vehicle.

The autonomous vehicle may be a first autonomous vehicle and the path may be a first path. The one or more processing devices may be configured to execute instructions to perform operations that include obtaining information about a second path that a second autonomous vehicle is to travel during movement of the second autonomous vehicle through the environment. Generating the virtual envelope may include: identifying a location where the first path is within a predefined distance of the second path; determining that the first autonomous vehicle will have to stop prior to the location; and basing a length of the virtual envelope on how much time that the first autonomous vehicle can travel before stopping prior to the location.

The one or more processing devices may be configured to execute instructions to perform operations that include determining that travel of the second autonomous vehicle takes precedence over travel of the first autonomous vehicle and, therefore, that the first autonomous vehicle will have to stop prior to the location. The travel of the second autonomous vehicle may take precedence over the travel of the first autonomous vehicle because the second autonomous vehicle is predicted to reach the location before the first autonomous vehicle.

Generating the virtual envelope may include: identifying a region where the autonomous vehicle is prohibited from entering; and basing a length of the virtual envelope on a proximity to the region.

Generating the virtual envelope may include: identifying a region where the autonomous vehicle has primacy; and extending the virtual envelope into the region prior to entry of one or more other autonomous vehicles into the region.

Generating the virtual envelope may include updating a shape of the virtual envelope dynamically based on at least one of a velocity of the autonomous vehicle or obstacles in the path or within a predefined distance of the path.

The at least two dimensions of the virtual envelope may include a first dimension that is parallel to at least part of the path and a second dimension that is perpendicular to the first dimension. Generating the virtual envelope may include changing at least a size of the first dimension.

Generating the virtual envelope may include combining polygons along the path to form a shape of the virtual envelope.

The virtual envelope that surrounds the autonomous vehicle may have at least three dimensions that are greater than three corresponding dimensions of the autonomous vehicle.

The one or more processing devices are part of a fleet management system that is external to the autonomous device. The one or more processing devices may be configured to execute instructions to transfer data representing the virtual envelope to the autonomous device. The autonomous vehicle may include an on-board control system that is configured to control the velocity of the autonomous vehicle based on the envelope.

The one or more processing devices may be part of an on-board control system of the autonomous device.

Any two or more of the features described in this specification, including in this summary section, can be combined to form implementations not specifically described herein.

The systems, processes, devices including autonomous vehicles, and variations thereof described herein, or portions thereof, can be implemented using, or may be controlled by, a computer program product that includes instructions that are stored on one or more non-transitory machine-readable storage media and that are executable on one or more processing devices. The systems, processes, devices including autonomous vehicles, and variations thereof described herein, or portions thereof, can be implemented as, or as part of, an apparatus, method, or electronic systems that can include one or more processing devices and memory to store executable instructions to implement various operations. The systems, processes, operations, devices including autonomous vehicles, and variations thereof described herein may be configured, for example, through design, construction, arrangement, composition, placement, programming, operation, activation, deactivation, and/or control.

The details of one or more implementations are set forth in the accompanying drawings and the description below. Other features and advantages will be apparent from the description and drawings, and from the claims.cc

### DESCRIPTION OF THE DRAWINGS

FIG. 1 is a side view of an example autonomous vehicle showing possible interior and exterior components of an example control system for the autonomous vehicle.

FIG. 2 is a perspective view of the example autonomous vehicle showing placement of sensors and examples of sensor ranges provided by those sensors.

FIG. 3 is a top view of an example map that may be used for path planning and navigation by an autonomous vehicle traveling through a space.

FIG. 4 is a flowchart showing operations that may be included in an example process for generating a virtual envelope around at least part of an autonomous vehicle and using the virtual envelope to control a velocity of the autonomous vehicle.

FIG. 5 is top view of an example autonomous vehicle and corresponding virtual envelope.

FIG. 6 is a top view of an example virtual envelope made of polygons.

FIGS. 7A and 7B are top views of an example of two autonomous vehicle avoiding a collision through the use of virtual envelopes.

FIG. 8 is a top view of another example of two autonomous vehicle avoiding a collision through the use of virtual envelopes.

FIGS. 9A and 9B are top views of another example of two autonomous vehicle avoiding a collision through the use of virtual envelopes.

FIG. 10 is a top view of an example of an autonomous vehicle using a virtual envelope to reserve entry into a room.

FIGS. 11A and 11B are top views of an autonomous vehicle using a virtual envelope to prevent entry into a room that it is prohibited to enter.

Like reference numerals in different figures indicate like elements.

### DETAILED DESCRIPTION

Described herein are example systems configured to control movement of one or more autonomous vehicles in an environment. The systems obtain information about paths that one or more autonomous vehicles are configured—e.g., programmed—to travel in the environment. For example, the systems receive information such as a projected or planned path of travel from an autonomous vehicle in the environment and generate a virtual envelope for the autonomous vehicle. The virtual envelope is sent to the autonomous vehicle and is updated as the autonomous vehicle travels.

The virtual envelope corresponds to the path of travel of the autonomous vehicle and defines a space in which the autonomous vehicle is to travel. The virtual envelope expands or contracts based on the presence of objects in the path of the autonomous vehicle. For example, the virtual envelope contracts when there is an object in the path of the autonomous vehicle and expands when there is no object in the path of the autonomous vehicle. Expansion and contraction of the envelope may occur along a continuum such that the distance between the autonomous vehicle and the object corresponds to a length of the virtual envelope. Expansion and contraction of the envelope may occur dynamically such that the closer the autonomous vehicle comes to the object, the more the virtual envelope contracts. Expansion and contraction of the envelope may occur in real-time while the autonomous vehicle is traveling. In this regard, in some implementations, real-time may not mean that actions are simultaneous, but rather may include actions that occur on a continuous basis or track each other in time, taking into account delays associated with processing, data transmission, hardware, and the like.

The velocity of the autonomous vehicle may controlled based on the size of the envelope. An example of the size of the virtual envelope is the length of the virtual envelope in the direction of travel. For example, the longer the virtual envelope is in the direction of travel, the greater the velocity of the autonomous vehicle may be. Conversely, the shorter the virtual envelope is in the direction of travel, the less the velocity of the autonomous vehicle may be. This correlation between the size, e.g., the length of the virtual envelope in the direction of travel, and the velocity of the autonomous vehicle enables the autonomous vehicle to stop or to slow down when the autonomous vehicle gets close to an object. That is, as the autonomous vehicle approaches the object, its velocity may be decreased due to the shortening of its virtual envelope, thereby making it easier for the autonomous vehicle to stop before a collision with the object. Conversely, when there are no objects within the autonomous vehicle's path, the virtual envelope for the autonomous vehicle may be at its maximum size indicating that the autonomous vehicle may operate at maximum velocity, thereby reducing the time it takes for the autonomous vehicle to reach its destination.

The virtual envelope may affect operation of the autonomous vehicle at any time during its travel. The virtual envelope may be particularly useful in cases where visual sensors on the autonomous vehicle are unable to detect an object. For example, the system may determine that two autonomous vehicles are about to enter a same doorway at about that same time if their velocities remain the same. The visual sensors on each autonomous vehicle may not be able to detect the approach of the other autonomous vehicle. The virtual envelopes, however, may control the velocities of both autonomous vehicles in order to avoid a collision in the doorway.

A virtual envelope may have two or more dimensions, each of which is greater than two or more corresponding dimensions of the autonomous vehicle. This configuration of the virtual envelope may be advantageous in that it enables some deviation in a planned path of travel for the autonomous vehicle. More specifically, in some examples, the autonomous vehicle generates information about a path that the autonomous vehicle is to travel in the environment. This information may be based, for example, on the autonomous vehicle's destination and a map of the environment that is available to—e.g., stored on or programmed into—the autonomous vehicle. By using a virtual envelope that is larger than the autonomous vehicle, particularly in the dimensions that is perpendicular to the direction of travel (e.g., the width of the autonomous vehicle), the autonomous vehicle is able to deviate somewhat from its path of travel while still being within the virtual envelope. As a result, the system need not update the autonomous vehicle's virtual envelope each time the autonomous vehicle encounters a minor obstacle that the autonomous vehicle needs to avoid.

The map includes typically static objects such as boundaries and landmarks in the environment. The map is usable by the autonomous vehicle for path planning. Path planning may include determining a path or route through the space to a destination. After the preferred path is determined, autonomous vehicle begins to move through the space along a path located on the map. The path and velocity of the autonomous vehicle are based on the virtual envelope. During this movement, the autonomous vehicle periodically or intermittently determines its location, orientation, or both location and orientation within the space. This information allows the autonomous vehicle to confirm that it is on the path, to determine where it is on the path, and to determine if a course correction is necessary to reach the destination. The autonomous vehicle uses elements in the space to determine its location along the path by comparing the elements that it detects using one or more sensors to expected locations of those same elements on the map. This information is sent to the system to update the virtual envelope, which is then sent back to the autonomous vehicle.

The operations described herein relating to controlling the autonomous vehicle using virtual envelopes may be implemented using one or more computing systems, such as the autonomous vehicle's control system and/or a fleet management system. The one or more computing systems may include hardware, software, or both hardware and software to implement map generation, path planning, localization, and virtual envelope generation and updating. In some implementations, all or part of the autonomous vehicle's control system may be “on-board” in the sense that all or part of the autonomous vehicle's control system is located on the robot itself. In some implementations, at least part of the autonomous vehicle's control system may be remote in the sense that all or part (at least part) of the autonomous vehicle's control system is not located on the autonomous vehicle itself. In some implementations, the fleet management system is remote from the autonomous vehicle's control system. In some implementations, the fleet management system may be considered to be part of the autonomous vehicle's control system. Examples of the autonomous vehicle's control system and the fleet management system are described below.

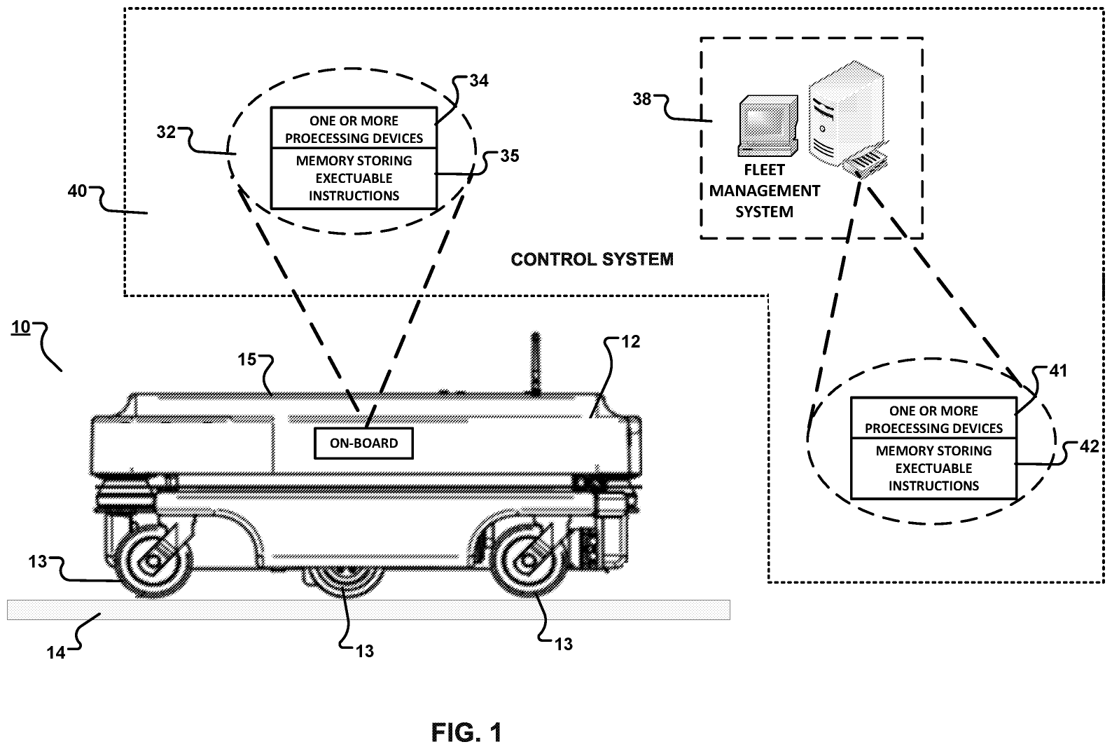

A non-limiting example of an autonomous vehicle configured to operate using the virtual envelopes described herein is robot 10 of FIG. 1. In this example, robot 10 is a mobile robot and is referred to as “robot 10” or “the robot”. Robot 10 includes a body 12 having wheels 13 to enable robot 10 to travel across a surface 14 of an environment, such as the floor of a warehouse, a factory, or other terrain. Robot 10 includes a support area 15 configured to support the weight of an object. In this example, robot 10 may be controlled to transport the object from one location to another location. Robot 10 includes various detectors—also referred to as sensors—for use in detecting elements in the vicinity of the robot. In some examples, an element may include animate objects and static objects such as inanimate objects, boundaries, or landmarks.

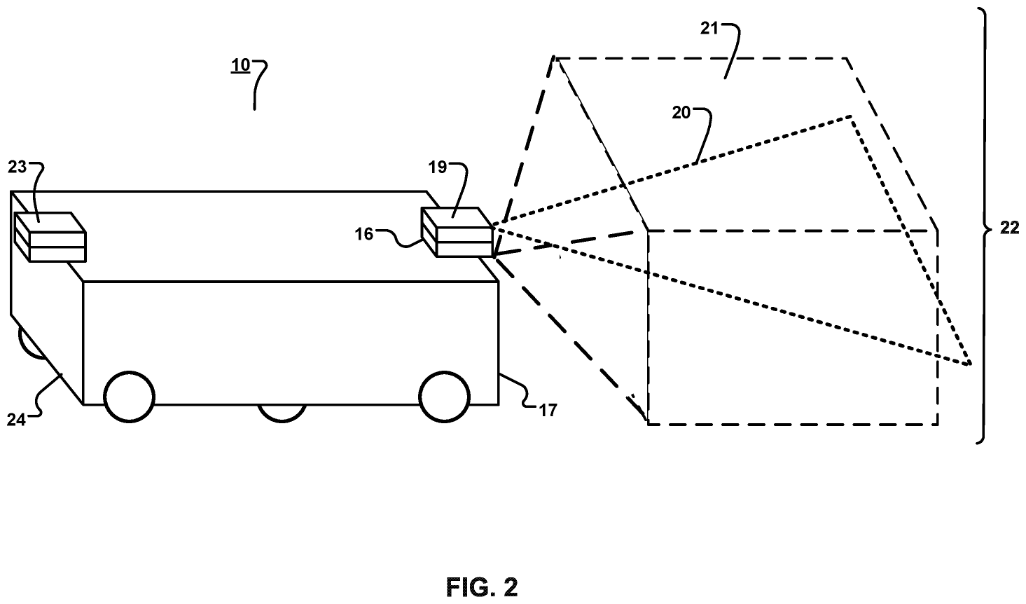

In this example, robot 10 includes different types of visual sensors, such as three-dimensional (3D) cameras, two-dimensional (2D) cameras, and light detection and ranging (LIDAR) scanners. A 3D camera is also referred to as an RGBD camera, where R is for red, G is for green, B is for blue, and D is for depth. The 3D camera may be configured to capture video, still images, or both video and still images. Notably, the robot is not limited to this configuration or to using these specific types of sensors. For example, the robot may include a single sensor or a single type of sensor or more than two types of sensors. Referring to FIG. 2, robot 10 includes 3D camera 16 at a front 17 of the robot. In this example, the front of the robot faces the direction of travel of the robot. The back of the robot faces terrain that the robot has already traversed.

Robot 10 also includes a light detection and ranging (LIDAR) scanner 19 at its front. In operation, the LIDAR scanner outputs a laser beam, which is reflected from an object in the environment. The difference in time between the incident laser beam and the reflected laser beam is used to determine the distance to the object and, thus, the location of the object within the environment. The laser beam is scanned in two dimensions (2D), so the LIDAR detection is in a plane relative to the robot.

More specifically, since the LIDAR scanner is 2D, it will detect elements in a plane 20 in the space that the robot is controlled to traverse. Since the camera is 3D, it will detect elements in 3D volume 21 in the space that the robot is controlled to traverse. LIDAR scanner 19 is adjacent to, and points in the same general direction as, 3D camera 16. Likewise, 3D camera 16 is adjacent to, and points in the same general direction as, LIDAR scanner 19. For example, the LIDAR scanner may be just below the 3D camera or the 3D camera may be just below the LIDAR scanner as shown in the example of FIG. 2. In this configuration, both the 3D camera and the LIDAR scanner are configured to view at least part of a same region 22 in front of the robot during travel. The front of the robot may contain multiple 3D camera/LIDAR scanner combinations although only one is shown. Robot 10 may also include one or more 3D camera/LIDAR scanner combinations 23 at its back 24. Robot 10 may also include one or more 3D camera/LIDAR scanner combinations (not shown) on its sides. Robot 10 may also include one or more 3D camera/LIDAR scanner combinations (not shown) on two or more of its corners—for example on two diagonally opposite corners. Each 3D camera/LIDAR scanner may be configured to view part of a same region.

A 2D camera may be used instead of, or in addition to, a 3D camera on robot 10. For example, for all instances described herein, one or more 2D cameras may be substituted for a 3D camera. To obtain 3D data of a region, two or more 2D cameras may be pointed at the same region and the captured 2D data correlated to obtain 3D data. In the example above, one or more 2D cameras and the LIDAR scanner may be configured to view at least part of a same region 22 in front of the robot during travel. Likewise, 2D cameras may be at the back or sides of the robot.

In this regard, in some implementations, additional or substitute sensors may be used. For example, the robot may include one or more one-dimensional (single beam) optical sensors, one or more two-dimensional (2D) (sweeping) laser rangefinders, one or more 3D high definition LIDAR sensors, one or more 3D flash LIDAR sensors, one or more 2D or 3D sonar sensors, and/or one or more 2D cameras. Combinations of two or more of these types of sensors may be configured to detect both 3D information and 2D information in the same region in front, back, or on the sides of the robot.

One or more of the sensors may be configured to continuously detect distances between the robot and elements in a vicinity of the robot. This may be done in order to perform path planning and to guide the robot safely around or between detected objects. While the robot is moving along a path, an on-board computing system may continuously receive input from the sensors. If an obstacle is blocking the trajectory of the robot, the on-board computing system is configured to plan a path around the obstacle. If an obstacle is predicted to block the trajectory of the robot, the on-board computing system is configured to plan a path around the obstacle. This information, which constitutes a deviation from a planned route through the environment, may be sent to a computing system, such as the fleet management system. The fleet management system may then update a virtual envelope (described below) for the robot and send the updated virtual envelope back to the robot. The velocity of the robot is then controlled based on the virtual envelope, as described herein.

The LIDAR scanners, the 3D cameras, and/or any other sensors on the robot make up a vision system for the robot. As noted, each mobile robot traveling through the space may include such a vision system and may contribute data, such as visual data, that is used to update the robot's path and, thus, its virtual envelope.

An example control system for the robot implements operations associated with the robot, such as map generation, path planning, and localization. In some implementations, the control system stores the map of the space in computer memory (“memory”). The map may be stored in memory on each robot or at any location that is accessible to the control system and to the robot. For example, the map may be stored at a remote computing system, such as a fleet management system. For example, the map may be stored at a remote server that is accessible to the robot, the control system, and/or the fleet management system. In some examples, remote access may include wireless access, such as access via a computer network or direct wireless link.

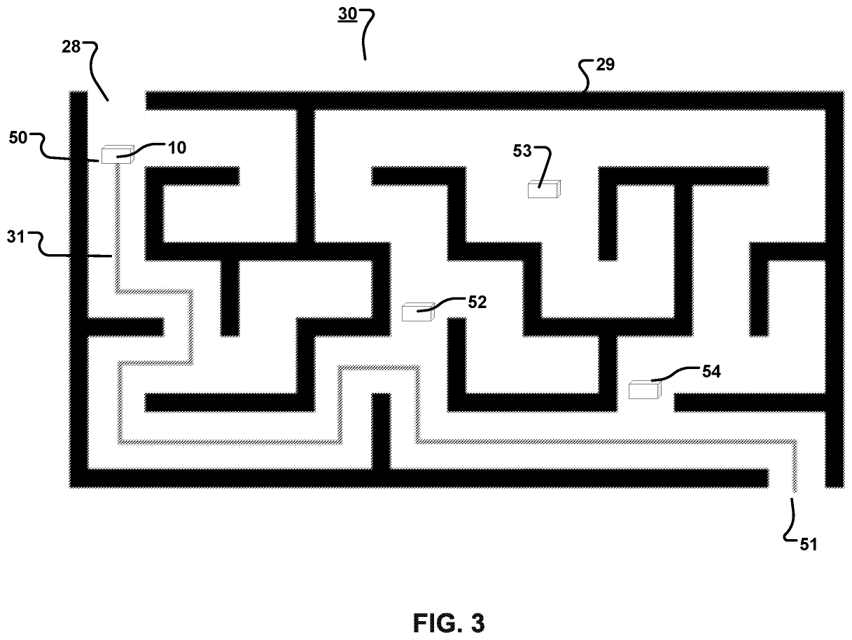

Referring to FIG. 3, map 30 may define boundaries of an environment or space 30 traveled through by the robot, such as walls 29 and doorways 28. The map may include locations of landmarks, such as columns, corners, windows, poles, and other distinguishable permanent and non-permanent features of the space that act as references for the robot during localization. The map may include objects, such as goods or containers within the space. The map also may also include measurements indicating the size of the space, measurements indicating the size and locations of the objects, boundaries, and landmarks, measurements indicating distances between different objects, boundaries, and landmarks, and coordinate information identifying where the objects, boundaries, and landmarks are located in the space. An example planned path or route through the space for the robot is labeled 31 in FIG. 3.

Referring back to FIG. 1, in some examples, the robot's control system 40 may include on-board components 32 configured to implement path planning and localization based on the map, to control a velocity of the robot based on a virtual envelope, and to provide the fleet management system with updates when the robot's path changes. The on-board components may include, for example, one or more processing devices 34 such as one or more microcontrollers, one or more microprocessors, programmable logic such as a field-programmable gate array (FPGA), one or more application-specific integrated circuits (ASICs), solid state circuitry, or any appropriate combination of two or more of these types of electronic components. The on-board components may include, for example, memory 35 storing machine-executable instructions that are executable by the one or more processing devices 35 to perform all or part of the functions described herein attributed to the robot and/or the on-board components of the control system.

In some implementations, on-board components of the control system may communicate with a remote computing system, such as a fleet management system 38. Fleet management system 38 is remote in the sense that it is not included on the robot. Components of fleet management system 38 may be at the same geographic location or distributed, for example, across different geographic locations. Components of the fleet management system 38 may be distributed among different robots in the space. Components of the fleet management system may include, for example, one or more processing devices 41 such as one or more microcontrollers, one or more microprocessors, programmable logic such as a an FPGA, one or more ASICs, solid state circuitry, or any appropriate combination of two or more of these types of electronic components. The components of the fleet management system 38 may include, for example, memory 42 storing machine-executable instructions that are executable by the one or more processing devices 41 to perform all or part of the functions described herein attributed to the fleet management system.

The fleet management system may be configured to control one or more robots within an environment such as those described herein. The fleet management system and each of the robots may include a copy of, or have access to, the same map of the space. The fleet management system may be configured to receive updated information about the actual position and operational status of each robot in a fleet of robots. The fleet management system may be configured to perform global path planning for the entire fleet and to generate and output virtual envelopes to the various robots, which the robots used to control their velocities, as described herein.

In some implementations, the control system, the robots, and the fleet management system may be configured to communicate over a wireless communication system, such as Local Area Network (LAN) having Wi-Fi, ZigBee, or Z-wave. Other networks that may also be used for communication between the control system, the robots, and the sensors include, but are not limited to, LoRa, NB-IoT (NarrowBand Internet of Things), and LTE (Long Term Evolution). In some implementations, the control system, the robots, and the fleet management system may be configured to communicate over a cellular network, such as a 5G cellular network configured to deliver peak data rates of up to 20 gigabits per second (Gbps) and average data rates exceeding 100 megabits per second (Mbps), having a latency between 8 and 30 milliseconds, and that uses and adaptive modulation and coding scheme (MCS) to keep the bit error rate (BLER) low, e.g., less than 1%.

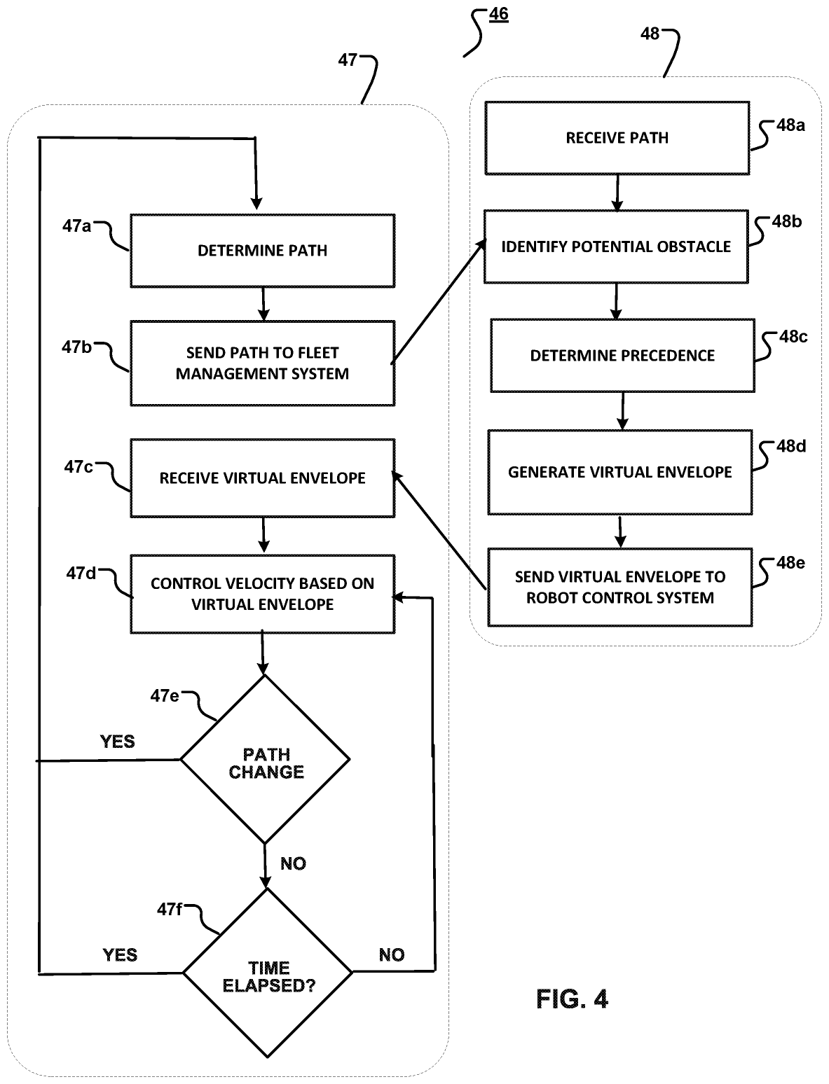

FIG. 4 shows an example process 46 configured to generate a virtual envelope around at least part of (e.g., all or part of) a robot 10 and to use the virtual envelope to control a velocity of the robot. Process 26 includes example operations 47, which may be performed on the on-board components 32 of the robot's control system, and example operations 48, which may be performed by the fleet management system 38 or other remote portion of the robot's control system.

Process 46 determines (47a) a path that robot 10 is to travel through the environment. For example, the robot may know its location in a map of the environment, such as map 30 of FIG. 3, using a localization process. The robot may also have its destination programmed into its on-board control system. Knowing its current location 50, its destination 51, and the map 30 of the environment, the robot can determine a path 31 (FIG. 3) from its current location to its destination 51. In making this determination, the robot may also take into account obstacles, such objects, that are within the view of its vision system. The path may be defined by data that includes a list of points between the current location and the destination. At each point, the path may include information about the orientation and velocity of the robot. At each point, the path may also include a projected time that the robot is to arrive at a next point in sequence between its current location and the destination.

Robot 10 sends (47b) data representing the path to the fleet management system 38. The fleet management system receives (48a) the data representing the path from the robot. The fleet management system also receives, before, during, or after receipt of robot 10's data, data representing the paths of one or more—for example, all—other robots 52, 53, 54 (FIG. 3) in the environment. The fleet management system knows the map 31 of the environment and knows where each robot in the environment is planned to be at any given time. Using this information, the fleet management system identifies (48b) any obstacles in the planned path of robot 10. Obstacles may include potential collisions with other robots in the environment, which are determined based on the planned paths of robot 10 and the other robots in the environment. In some examples, a potential collision may include an intersection of two robot paths in which each robot is expected to be at the same point in the environment at the same time based on their planned paths. In some examples, a potential collision may include two robot paths that are within a predefined proximity of each other such that the robots traveling along those paths will be unacceptably close to each other at some point in time. For example, their paths may not intersect, but the paths may be so close that the two robots will definitely collide. The sizes of the robots affect how close to robots can some to each other and collide or not collide. In another example of a potential collision, two robots' paths may not intersect, but the paths may be so close that there is a possibility that the two robots may collide. For example, one or both of the robots may deviate somewhat from their planned paths due to obstacles or other factors in the environment. Given these potential deviations, there is an unacceptable chance that the robots will collide. For example, if the robot's paths are within 30 centimeters (cm), 40 cm, 50 cm, 60 cm, or less of each other, depending on the sizes of the robots, there is an unacceptable chance that the robots will collide. That is, the robots are close enough to each other at some point along their paths that they may collide if they deviate from their projected path by 5%, 10%, 15%, 20%, and so forth.

For each potential collision, the fleet management system determines (48c) which of two, or more, robots involved in a potential collision has precedence. Precedence, in this context, may include which robot is entitled to proceed first if two (or more) robots are expected to be in a situation where there is a potential collision. Precedence may be based on any appropriate factors, such as whether a robot is carrying cargo, with robots carrying cargo being given precedence over robots not carrying cargo; which robot is traveling faster, with robots traveling faster being given precedence over robots traveling slower; which robot is projected to reach a location first, with robots reaching a location first being give precedence over robots arriving later; which robot's task has greater priority, with robots having greater priority tasks being given precedence over robots having lower priority tasks; which robot has a shorter deadline to reach its destination, with robots having a shorter deadline being given precedence over robots having longer deadlines, and/or other factors.

The fleet management system generates (48d) a virtual envelope for robot 10 based on the existing of a potential collision and whether that robot takes precedence over one or more other robots that may be involved in the potential collision. The virtual envelope is indicative of the velocity of the robot for a predefined time in the future.

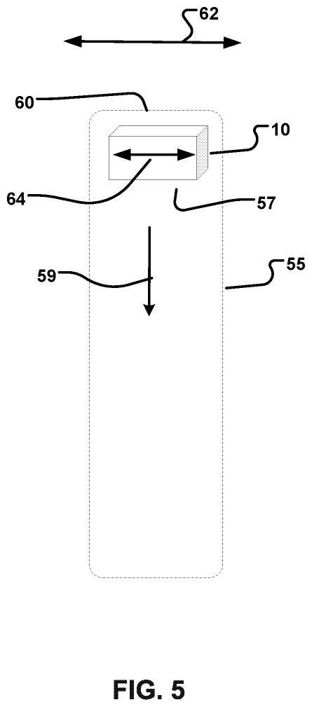

FIG. 5 shows an example virtual envelope 55 for robot 10. As shown, virtual envelope 55 extends around robot 10 and primarily in front 57 of the robot along its planned direction of travel represented by arrow 59. In some implementations, the virtual envelope does not extend beyond the back 60 of the robot; however, in some implementations, the virtual envelope may extend outward from the back 60 of the robot a shorter distance that the virtual envelope extends in the front. This may be done to prevent premature travel of another robot after a potential collision point. The size—for example, the length—of the virtual envelope in the direction of travel may be indicative of the velocity that the robot may travel for a predefined duration (e.g., period of time). In some implementations, that duration is 3 seconds(s), 4 s, 5 s, 6 s, or more. In some implementations, the longer the virtual envelope is, the faster the robot may travel for the predefined duration, since a longer envelope indicates no upcoming stops for the robot within the predefined duration or that any stops within the predefined duration are relatively far from the robot's current location (e.g., close to 3 s away if the predefined duration is 3 s). The length of the virtual envelope therefore may be associated with predefined velocities of the robot. For example, if the virtual envelope has a predefined maximum length, then the robot may travel at a predefined maximum speed in the direction of travel for the predefined duration. If the virtual envelope has 50% of a predefined maximum length, then the robot may travel at 50% of a predefined maximum speed in the direction of travel for some time less than (e.g., half of) the predefined duration. If the virtual envelope has 25% of a predefined maximum length, then the robot may travel at 25% of a predefined maximum speed in the direction of travel for some time less than (e.g., one quarter of) the predefined duration; and so forth. Although the direction of travel is linear in the example of FIG. 5, in other examples described below, the direction of travel may be non-linear.

The size—for example, the length—of the virtual envelope in the direction of travel may be indicative of the velocity that the robot may travel for a predefined duration without stopping. For example, if the fleet management system knows a location where the robot must stop, then the length of the virtual envelope will be based on the duration that the robot may travel before that location. Places where the robot may be required to stop may include at doorways or in front of other robots.

The virtual envelope may also extend laterally—e.g., perpendicularly—relative to the direction 59 of travel. In this example, the virtual envelope extends in the directions of arrow 62 relative to robot 10 so that the size the virtual envelope is also based on the footprint of the robot. For example, the virtual envelope may be 5% wider than the width 64 robot 10, 10% wider than robot 10, 15% wider than robot 10, 20% wider than robot 10, and so forth. In some examples, the virtual envelope may extend outward 10 cm on each side or robot 10, 15 cm on each side of robot 10, 20 cm on each side of robot 10, 30 cm on each side of robot 10, and so forth. In some implementations, the virtual envelop may not extend beyond the width 64 of robot 10 (not shown).

An advantage of the virtual envelope extending beyond the width 64 of robot 10 is that the robot has leeway to replan its path without requiring reporting to the fleet management system. For example, if the robot detects an object, such as a box, within its path, the robot may move within the confines of the virtual envelope to avoid the box without calculating a new path and sending that path back to the fleet management system. This may reduce the time that it takes the robot to travel to its destination and the amount of processing required by the fleet management system.

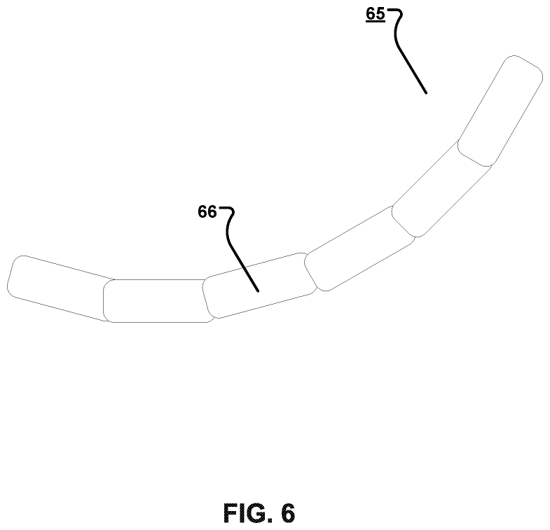

Referring to FIG. 6, a virtual envelope 65 may be constructed of multiple polygons 66 that that overlap at least in part. In the example of FIG. 6 the virtual envelope is constructed using rounded rectangles; however, any polygon may be used.

Referring back to FIG. 4, fleet management system 38 sends (48e) the virtual envelope to the robot. The on-board control system of the robot, for example, receives (47c) the virtual envelope and stores it in memory 35. The on-board control system of robot 10 controls (47d) the velocity of the robot for a duration—for example, the predetermined duration such as 3 s or the time that the robot can travel without stopping—based on the length of the virtual envelope in the direction of travel. For example, If the virtual envelope has 50% of a predefined maximum length, then the robot may travel at 50% of a predefined maximum speed in the direction of travel for a duration.

During travel, the robot's vision system continues to monitor the robot's surroundings. If there is a relatively small obstacle in the direction of travel or the robot needs to make a minor course correction, the robot is free to maneuver within the virtual envelope without changing its path (47e). This maneuverability may be referred to as localized replanning, since the robot may replan its path within the confines of the virtual envelope based, e.g., on information from its vision system. This maneuverability is due, as explained above, to the width of the virtual envelope being greater than the width of the robot. If, however, the visions system detects a larger object in the robot's path, then the robot's on-board control system determines (47a) a new path and process 46 proceeds as show in FIG. 4 to obtain an updated virtual envelope for the new path. If there is no path change, and the time (e.g., predetermined time or the time before stopping) has not elapsed (47f), the robot's on-board control system continues to control (47d) the velocity of the robot using the current virtual envelope. After the time has elapsed (e.g., the robot has stopped or the predetermined time has passed), the robot's on-board control system determines (47a) a new path and process 46 proceeds as show in FIG. 4 to obtain an updated virtual envelope for the new path.

Examples of using the virtual envelopes to control velocity in accordance with process 46 of FIG. 4 are described below.

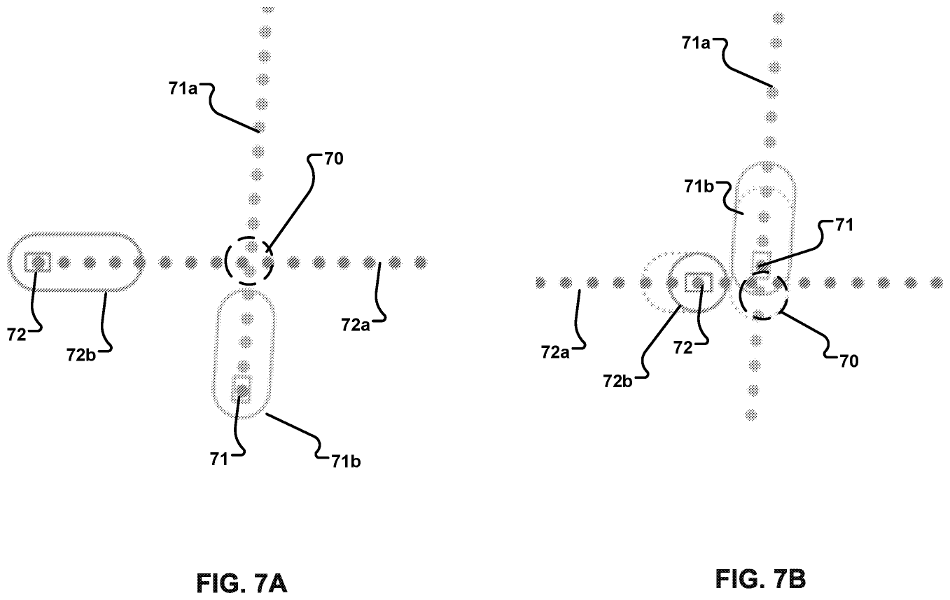

Referring to the example of FIGS. 7A and 7B, the fleet management system 38 identified an intersection 70 of two respective planned paths 71a, 72a of robots 71, 72. The intersection is a potential collision point. As the two robots approach intersection 70 as shown in FIG. 7A, the virtual envelopes of the robots may be expanded (e.g., lengthened in the direction of travel) or contracted (e.g., shortened in the direction of travel) by the fleet management system depending on which robot has precedence in this situation. In FIG. 7A, the virtual envelopes 71b, 72b are at their maximum, since neither robot is within stopping distance or a predefined duration of reaching intersection 70. In this example robot 71 has precedence. Accordingly, as the two robots travel, their virtual envelopes are updated by the fleet management system based on their planned paths and/or based on input from their vision systems. Since robot 70 has precedence, its virtual envelope does not change—for example, it remains at its current size across the intersection point 70 indicating that robot 10 may continue on its path 71 at its current velocity. The dotted version or virtual envelope 71b shows the virtual envelope at a different point in time than the solid version of virtual envelope 71b. By contrast, robot 72 does not have precedence. Accordingly, robot 72's virtual envelope contracts, as shown in FIG. 7B. The dotted version or virtual envelope 72b shows the virtual envelope at a different point in time that the solid version of virtual envelope 72b. This shorter virtual envelope 72b indicates the amount of time that the robot can travel before stopping prior to intersection point 70. Accordingly, in this example, the on-board control system of robot robot 72 slows the speed of robot 72, possibly (but not necessarily) to an eventual stop, prior to the intersection point 72 based on the size of virtual envelope 72b in the direction of travel in order to allow robot 71 to pass through the intersection point.

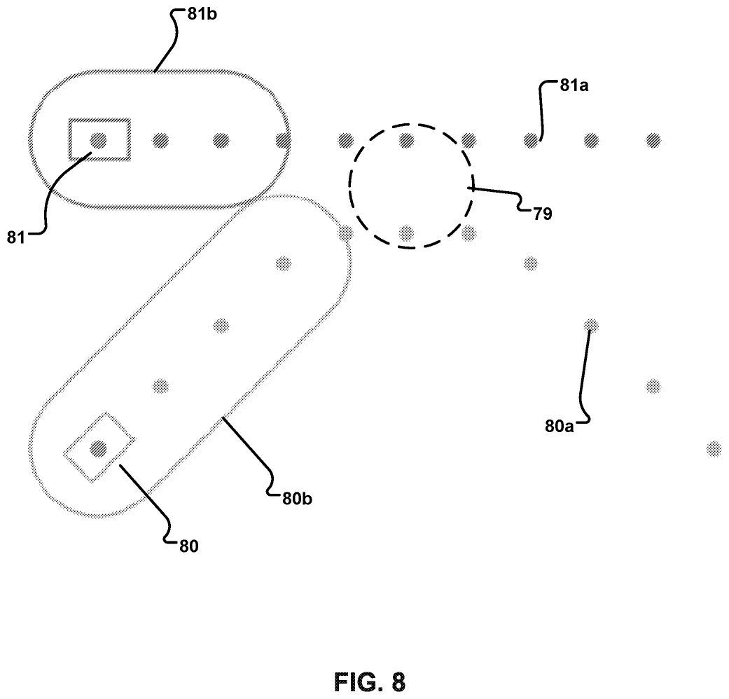

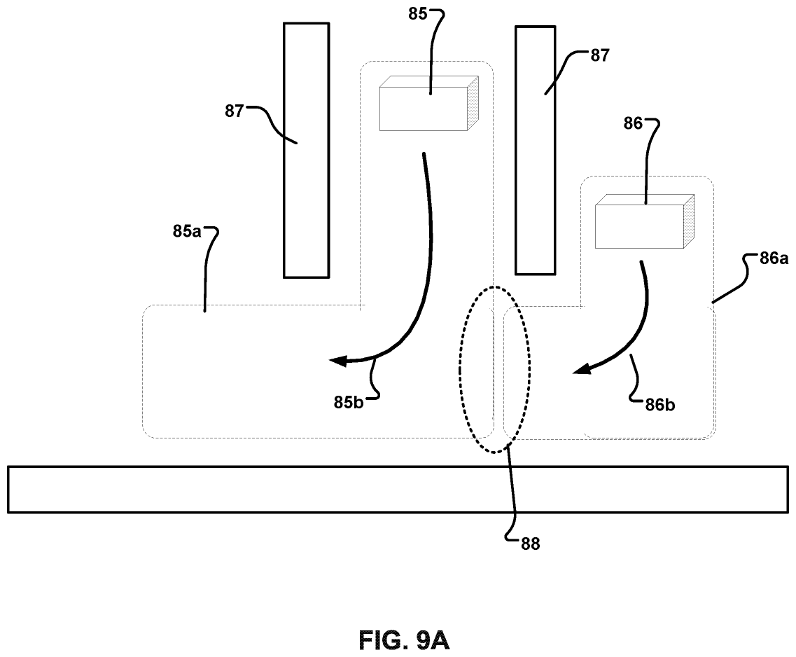

In another example shown in FIG. 8, robots 80 and 81 approach a potential collision point 79. Although their paths 80a and 81a do not intersect, if robots 80 and 81 both proceeded at maximum velocity, robots 80 and 81 will collide, as determined by the fleet management system 38. In this example robot 80 has precedence. Since robot 80 has precedence, its virtual envelope 80b does not change—for example, it remains at its current size across the intersection point 79 indicating that robot 80 may continue on its path 81 at its current velocity. By contrast, robot 81 does not have precedence. Accordingly, robot 81's virtual envelope 81b contracts, as shown in FIG. 8 by the fact that virtual envelope 81b is shorter than virtual envelope 80b. This shorter virtual envelope 81b indicates the amount of time that the robot 81 can travel before stopping. Accordingly, the on-board control system of the robot 81 is slows its speed, possibly to an eventual stop, prior to the intersection point 79 based on the size of virtual envelope 81b in order to allow robot 80 to pass through intersection point 79.

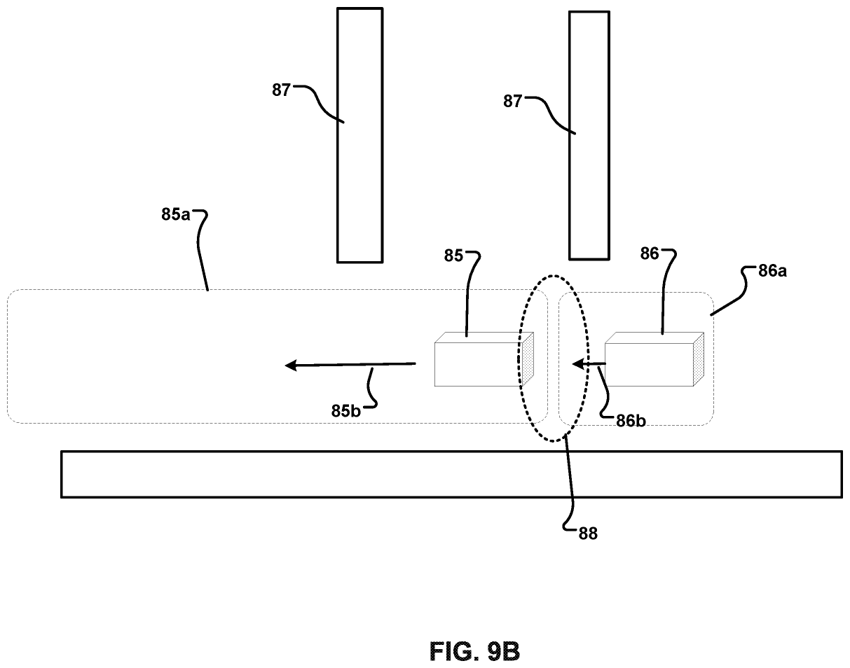

FIGS. 9A and 9B show two robots 85 and 86 which are not in visual range of each other due to walls 87 along their respective directions of travel 85b and 86b. Referring to FIG. 9A, a projected potential collision point is in region 88. In this example, robot 85 has precedence. Accordingly, the virtual envelope 85a of robot 85 is longer indicating that robot 85 may continue on its present path identified by arrow 85b at maximum or greater velocity than robot 86 may travel. By contrast, robot 86 does not have precedence. Accordingly, the virtual envelope 86b of robot 86 is shorter indicating the amount of time that the robot 86 can travel before stopping. Referring to FIG. 9B, as robots 85 and 86 approach the potential collision point 88, robot 85 may continue to proceed along its path 85b without slowing, as indicated by the length of its virtual envelope 85a. By contrast, robot 86 slows, and potentially stops, along its path 86b, as indicated by how much its virtual envelope 86a has contracted.

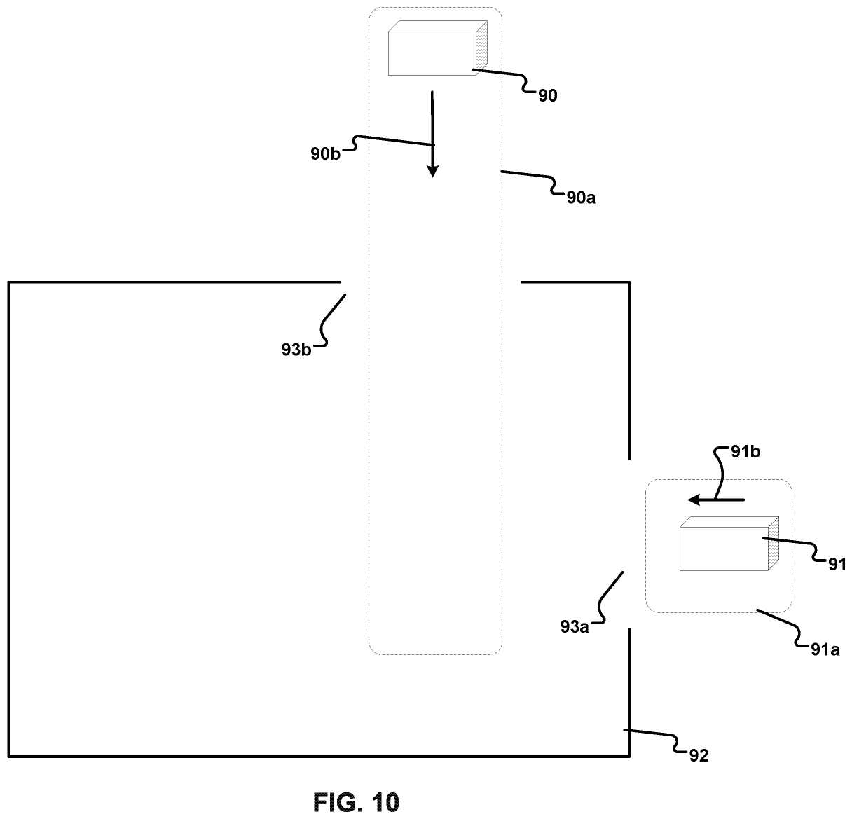

In some implementations, virtual envelopes may be used to reserve space within an environment. In the example of FIG. 10, robots 90 and 91 are both moving into a room 92 through different entries 93a, 93b. Robot 91 is closer to entering the room than robot 90. However, robot 90 has precedence over robot 91, as defined by the fleet management system 38. That is, robot 90 has priority over movement into, and within, room over robot 91. Accordingly, the fleet management system may expand robot 90's virtual envelope 90a in its direction 90b of travel of robot 90 to the inside of room 92 and contract robot 91's virtual envelope 91a in its direction of travel 91b. As a result, robot 91 may slow down or stop outside or room 92, whereas robot 90 may continue into room at its maximum velocity or any appropriate velocity even though robot is closer to entering room 92 than robot 90.

in some implementations, virtual envelopes may be used to determine which of two robots may pass through a doorway or other passage first. For example, if two robots approach a doorway, the fleet management system may expand the virtual envelope of the robot having precedence through the doorway. The virtual envelope of the other robot may contract to indicate that it has to slow down or stop to allow the robot having precedence to proceed through the doorway.

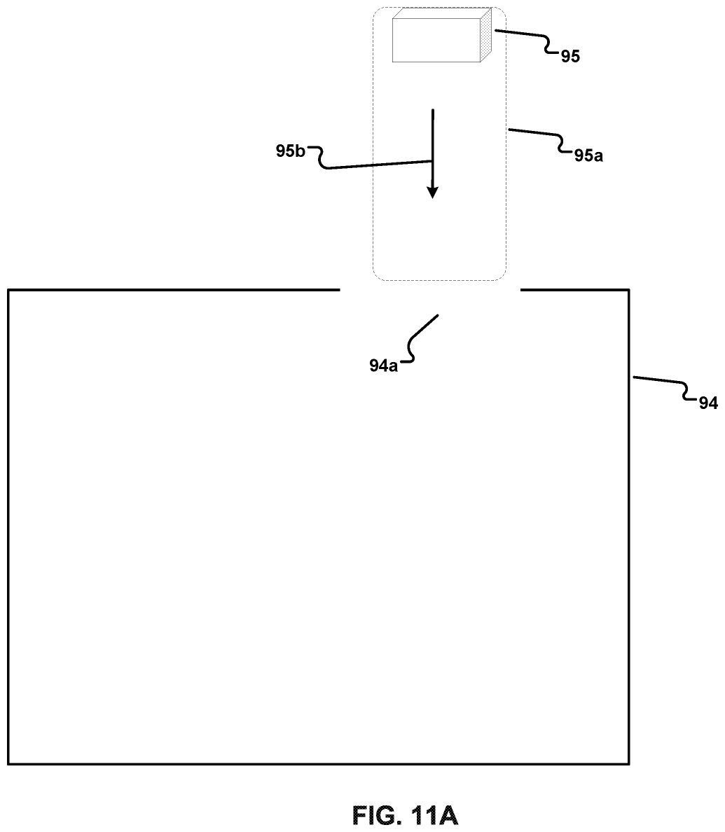

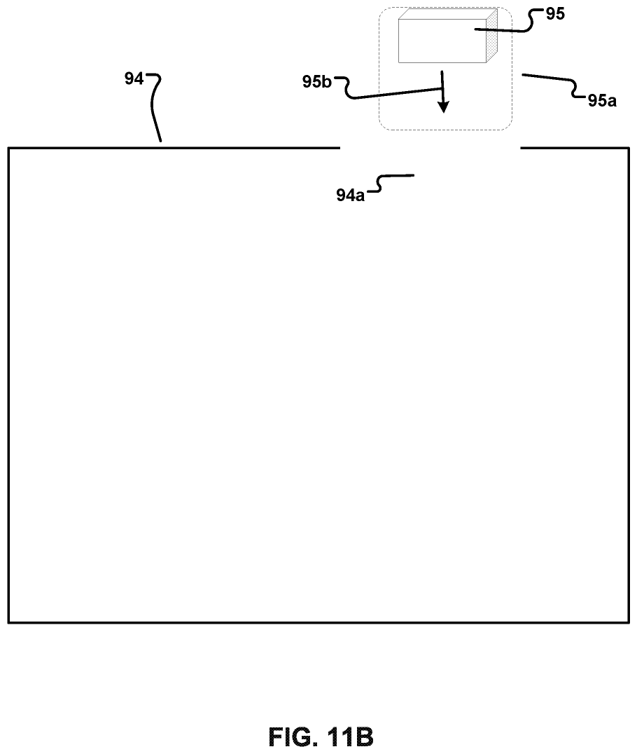

In some implementations, virtual envelopes may be used to prevent a robot from entering a space that it is prohibited from entering. In the example of FIGS. 11A and 11B, robot 95 is traveling 95b toward the entry 94a of room 94. As robot 95 approaches the entry, its virtual envelope 95b contracts from the length shown in FIG. 11A to the length shown in FIG. 11B, causing its velocity to slow and the robot to eventually stop. The fleet management system may thus prevent robot 95 from entering room 94

The techniques described herein, and variations thereof, are not limited to the autonomous vehicle described with respect to FIGS. 1 and 2. For example, the techniques described herein, and variations thereof, may be used on any appropriate mobile device such as the mobile robot described in U.S. Patent Publication No. 2021/0349468 (published Nov. 11, 2021) with respect to FIGS. 1, 2, and 3 thereof. The contents of U.S. Patent Publication No. 2021/0349468 relating to the description of the autonomous vehicle are incorporated herein by reference. In other examples, the techniques described herein, and variations thereof, may be used with self-driving automobiles. In still other examples, the techniques described herein, and variations thereof, may be used with aerial drones. In the case of aerial drones or other devices that are not limited to driving along a surface, the virtual envelopes described herein may have three dimensions; that is, the envelopes may be formed from multiple rectangular cuboids arranged in a sequence and in three dimensions. The operations described herein would be the same, except extended to three dimensions.

The example autonomous vehicles and systems described herein may include, and the processes described herein may be implemented using, a control system comprised of one or more computer systems comprising hardware or a combination of hardware and software. For example, a autonomous vehicles, the control system, or both may include various controllers and/or processing devices located at various points in the system to control operation of its elements. A central computer may coordinate operation among the various controllers or processing devices. The central computer, controllers, and processing devices may execute various software routines to effect control and coordination of the various automated elements.

The example autonomous vehicles and systems described herein can be controlled, at least in part, using one or more computer program products, e.g., one or more computer program tangibly embodied in one or more information carriers, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing at least part of the robot can be performed by one or more programmable processors executing one or more computer programs to perform the functions described herein. At least part of the robot can be implemented using special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, e.g., magnetic, magneto-optical disks, or optical disks.

Machine-readable storage media suitable for embodying computer program instructions and data include all forms of non-volatile storage area, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks.

In the description and claims provided herein, the adjectives “first”, “second”, “third”, and the like do not designate priority or order. Instead, these adjectives are used solely to differentiate the nouns that they modify.

Any mechanical or electrical connection herein may include a direct physical connection or an indirect connection that includes intervening components.

Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

What is claimed is:

1. A method comprising:
obtaining information about a path that an autonomous vehicle is to travel during movement of the autonomous vehicle through an environment; and
generating a virtual envelope that surrounds the autonomous vehicle and that has at least two dimensions that are greater than two corresponding dimensions of the autonomous vehicle, where a length of the virtual envelope along the path is based on at least one of (i) a predefined duration that the autonomous vehicle can travel along the path or (ii) a duration that the autonomous vehicle can travel along the path without stopping, and where a velocity of the autonomous vehicle is based on the virtual envelope.

2. The method of claim 1, wherein the autonomous vehicle is a first autonomous vehicle and the path is a first path; and
wherein generating the virtual envelope comprises:
identifying an intersection of the first path and a second path that a second autonomous vehicle is to travel during movement of the second autonomous vehicle through the environment;
determining that the first autonomous vehicle will have to stop prior to the intersection; and
basing a length of the virtual envelope on how much time that the first autonomous vehicle can travel before stopping prior to the intersection.

3. The method of claim 2, further comprising:
determining that travel of the second autonomous vehicle takes precedence over travel of the first autonomous vehicle and, therefore, that the first autonomous vehicle will have to stop prior to the intersection.

4. The method of claim 3, wherein the travel of the second autonomous vehicle takes precedence over the travel of the first autonomous vehicle because the second autonomous vehicle is predicted to reach the intersection before the first autonomous vehicle.

5. The method of claim 1, wherein the autonomous vehicle is a first autonomous vehicle and the path is a first path; and
wherein generating the virtual envelope comprises:
identifying a location where the first path is within a predefined distance of a second path that a second autonomous vehicle is to travel during movement of the second autonomous vehicle through the environment;
determining that the first autonomous vehicle will have to stop prior to the location; and
basing a length of the virtual envelope on how much time that the first autonomous vehicle can travel before stopping prior to the location.

6. The method of claim 5, further comprising:
determining that travel of the second autonomous vehicle takes precedence over travel of the first autonomous vehicle and, therefore, that the first autonomous vehicle will have to stop prior to the location.

7. The method of claim 6, wherein the travel of the second autonomous vehicle takes precedence over the travel of the first autonomous vehicle because the second autonomous vehicle is predicted to reach the location before the first autonomous vehicle.

8. The method of claim 1, wherein generating the virtual envelope comprises:
identifying a region where the autonomous vehicle is prohibited from entering; and
basing a length of the virtual envelope on a proximity to the region.

9. The method of claim 1, wherein generating the virtual envelope comprises:
identifying a region where the autonomous vehicle has primacy; and
extending the virtual envelope into the region prior to entry of one or more other autonomous vehicles into the region.

10. The method of claim 1, wherein generating the virtual envelope comprises updating a shape of the virtual envelope dynamically based on at least one of a velocity of the autonomous vehicle or obstacles in the path or within a predefined distance of the path.

11. The method of claim 1, wherein the at least two dimensions comprise a first dimension that is parallel to at least part of the path and a second dimension that is perpendicular to the first dimension.

12. The method of claim 11, wherein generating the virtual envelope comprises changing at least a size of the first dimension.

13. The method of claim 11, wherein generating the virtual envelope comprises:
combining polygons along the path to form a shape of the virtual envelope.

14. The method of claim 1, wherein the virtual envelope that surrounds the autonomous vehicle has at least three dimensions that are greater than three corresponding dimensions of the autonomous vehicle.

15. One or more non-transitory machine-readable storage media storing instructions that are executable to perform operations comprising:
obtaining information about a path that an autonomous vehicle is to travel during movement of the autonomous vehicle through an environment; and
generating a virtual envelope that surrounds the autonomous vehicle and that has at least two dimensions that are greater than two corresponding dimensions of the autonomous vehicle, where a length of the virtual envelope along the path is based on at least one of (i) a predefined duration that the autonomous vehicle can travel along the path or (ii) a duration that the autonomous vehicle can travel along the path without stopping, and where a velocity of the autonomous vehicle is based on the virtual envelope.

16. A system comprising:
an autonomous vehicle; and
one or more processing devices configured to execute instructions to perform operations comprising:
obtaining information about a path that the autonomous vehicle is to travel during movement of the autonomous vehicle through an environment; and
generating a virtual envelope that surrounds the autonomous vehicle and that has at least two dimensions that are greater than two corresponding dimensions of the autonomous vehicle, where a length of the virtual envelope along the path is based on at least one of (i) a predefined duration that the autonomous vehicle can travel along the path or (ii) a duration that the autonomous vehicle can travel along the path without stopping;
wherein the autonomous vehicle is configured to use the virtual envelope to control a velocity of the autonomous vehicle.

17. The system of claim 16, wherein the autonomous vehicle is a first autonomous vehicle and the path is a first path;
wherein the one or more processing devices are configured to execute instructions to perform operations comprising obtaining information about a second path that a second autonomous vehicle is to travel during movement of the second autonomous vehicle through the environment; and
wherein generating the virtual envelope comprises:
identifying an intersection of the first path and the second path;
determining that the first autonomous vehicle will have to stop prior to the intersection; and
basing a length of the virtual envelope on how much time that the first autonomous vehicle can travel before stopping prior to the intersection.

18. The system of claim 16, wherein the one or more processing devices are configured to execute instructions to perform operations comprising:
determining that travel of the second autonomous vehicle takes precedence over travel of the first autonomous vehicle and, therefore, that the first autonomous vehicle will have to stop prior to the intersection.

19. The system of claim 18, wherein the travel of the second autonomous vehicle takes precedence over the travel of the first autonomous vehicle because the second autonomous vehicle is predicted to reach the intersection before the first autonomous vehicle.

20. The system of claim 16, wherein the autonomous vehicle is a first autonomous vehicle and the path is a first path;
wherein the one or more processing devices are configured to execute instructions to perform operations comprising obtaining information about a second path that a second autonomous vehicle is to travel during movement of the second autonomous vehicle through the environment; and
wherein generating the virtual envelope comprises:
identifying a location where the first path is within a predefined distance of the second path;
determining that the first autonomous vehicle will have to stop prior to the location; and
basing a length of the virtual envelope on how much time that the first autonomous vehicle can travel before stopping prior to the location.

21. The system of claim 16, wherein the one or more processing devices are configured to execute instructions to perform operations comprising:
determining that travel of the second autonomous vehicle takes precedence over travel of the first autonomous vehicle and, therefore, that the first autonomous vehicle will have to stop prior to the location.

22. The system of claim 21, wherein the travel of the second autonomous vehicle takes precedence over the travel of the first autonomous vehicle because the second autonomous vehicle is predicted to reach the location before the first autonomous vehicle.

23. The system of claim 16, wherein generating the virtual envelope comprises:
identifying a region where the autonomous vehicle is prohibited from entering; and
basing a length of the virtual envelope on a proximity to the region.

24. The system of claim 16, wherein generating the virtual envelope comprises:
identifying a region where the autonomous vehicle has primacy; and
extending the virtual envelope into the region prior to entry of one or more other autonomous vehicles into the region.

25. The system of claim 16, wherein generating the virtual envelope comprises updating a shape of the virtual envelope dynamically based on at least one of a velocity of the autonomous vehicle or obstacles in the path or within a predefined distance of the path.

26. The system of claim 16, wherein the at least two dimensions comprise a first dimension that is parallel to at least part of the path and a second dimension that is perpendicular to the first dimension.

27. The system of claim 26, wherein generating the virtual envelope comprises changing at least a size of the first dimension.

28. The system of claim 26, wherein generating the virtual envelope comprises:
combining polygons along the path to form a shape of the virtual envelope.

29. The system of claim 16, wherein the virtual envelope that surrounds the autonomous vehicle has at least three dimensions that are greater than three corresponding dimensions of the autonomous vehicle.

30. The system of claim 16, wherein the one or more processing devices are part of a fleet management system that is external to the autonomous device;
wherein the one or more processing devices are configured to execute instructions to transfer data representing the virtual envelope to the autonomous device; and
wherein the autonomous vehicle comprises an on-board control system that is configured to control the velocity of the autonomous vehicle based on the envelope.

31. The system of claim 16, wherein the one or more processing devices are part of an on-board control system of the autonomous device.
